(19) United States
(12) Patent Application Publication
(10) Pub. No.: US 2013/0117122 A1
(43) Pub. Date: May 9, 2013

(54) Methods and Systems for Providing A Location-Based Legal Information and Imaging Service

(71) Applicant: EA Ventures, LLC, Hamden, CT (US)

(72) Inventors: Earl Cooper, Milford, CT (US); Alexander H. Kuehling, St. Louis, MO (US)

(73) Assignee: EA Ventures, LLC, Hamden, CT (US)

(21) Appl. No.: 13/667,280

(22) Filed: Nov. 2, 2012

Related U.S. Application Data
(60) Provisional application No. 61/555,216, filed on Nov. 3, 2011.

(51) Int. Cl. G06Q 50/18; G06Q 30/02

(52) U.S. Cl. 705/14.58; 705/311

(57) ABSTRACT

A method, system, apparatus, and computer product is presented for a location-based legal information and advertising service. A user of this service is assumed to have a mobile data device whose location may be determined by geolocation technology or user input. Once a particular location of interest has been determined, the device can display a variety of categories or fields of law that a user may select from. Upon user selection, data regarding the user can be stored in a database and information based upon the user's selection of a category or field of law and particular locations, and can be further retrieved and displayed. Additionally, the method, system, apparatus, and computer product may retrieve and display an advertisement or an image based upon the user's selection of a category or field of law and particular location of interest.

### CROSS-REFERENCE TO RELATED APPLICATIONS

This application claims the benefit of co-pending, commonly assigned U.S. Provisional Patent Application No. 61/555,216, which was filed on Nov. 3, 2011. The entire contents of the foregoing provisional patent application are incorporated herein by reference.

### TECHNICAL FIELD

The present disclosure relates to methods and systems for providing a location-based legal information and imaging service and, in particular, to methods and systems for providing location-based legal information and imaging based on a user selection of at least one category of law or field of law.

### BACKGROUND

Laws are generally premised on the fiction that everyone knows the law and understands his or her legal obligations. As the famous maxim states, ignorance of the law is no defense. Yet, despite the fact that citizens are responsible for conforming their conduct to abide by the law, few citizens actually understand the law. Any method or system that better educates citizens on their legal responsibilities and rights has tremendous social value.

Citizens usually acquire their legal knowledge from common sense, conversations with family members and friends, and from overly dramatized, and often inaccurate, television programs. Since knowledge of the law is limited, many citizens violate the law oblivious to the fact that they are violating it. It is theorized that the better a citizen understands the law, the more likely he or she is to conform his or her actions so as to abide by the law.

When a citizen confronts a situation where a legal right or responsibility is implicated, they may take an imprudent course of action because of the lack of knowledge. Unfortunately, this may have permanent effects. Not invoking a particular right in that instance could result in losing that right forever. Not conforming to a legal responsibility in a specific instance could have far reaching legal effects that cannot be reversed.

Unfortunately, it is often a difficult, time-consuming, and expensive process for the average citizen to gain access to reliable legal information. It is generally expensive to consult or retain the services of an attorney. While some citizens may be self-motivated to educate themselves on the law, statutes and regulations are often written in language that is confusing for most laypersons. Additionally, legal information is often stored in libraries and databases that are not readily accessible to a citizen when the citizen may need the information. In some situations, legal rights may be permanently waived if not acted upon in an expedient manner.

Concepts such as federalism often hinder citizens' legal comprehension since each citizen is subject to countless laws and regulations that are promulgated by numerous entities. At times, a citizen may not know what particular jurisdiction he or she is located in, especially if he or she is in unfamiliar territory. In addition, citizens may also have a difficult time finding quality legal representation that is affordable. For instance, in the United States, the percentage of litigants that appear in court pro se, or not represented by an attorney, is generally high, even though the unemployment rate amongst attorneys is also high.

While some prior art provides citizens with legal information, the prior art does not utilize the available technology to optimally assist a citizen. The prior art primarily necessitates citizens to retrieve information from stationary locations, such as a desktop or laptop computer. Legal issues that require immediate attention can arise anywhere, and the continued distribution of information through stationary means often hinders access to pertinent legal information. However, the advent of portable mobile data devices allows information to be delivered to a mobile data device no matter where a user is located. Furthermore, much of the prior art generally relies upon citizens to understand the applicable jurisdiction when they are researching legal issues.

Thus, a need exists for systems and methods that utilize geolocation technology and user input regarding particular categories or fields of law to display legal information, interactive images, advertising, and the like, applicable to the determined location in an instantaneously accessible form. A further need exists for a combination of geolocation technology with a user's selection of a particular category or field of law to improve an attorney's ability to advertise his or her services to prospective clients, and for citizens to better understand their options for legal representation. These and other needs are addressed by the systems and methods of the present disclosure.

### SUMMARY

The exemplary method, system, or apparatus described herein provides for legal information and/or advertising service that utilizes, e.g., geolocation technology, a positioning system, and the like, and user input regarding particular categories or fields of law to display information on a mobile data device in a unique manner. The method, system, or apparatus described herein determines the jurisdiction of a mobile data device with geolocation technology such as, but not limited to, the Global Positioning System (“GPS”), or a manual user input. The device then displays a variety of categories or fields of law that a user may select from. After a user selection, the relevant legal information can be retrieved and displayed on the mobile data device for the user's entertainment and/or education. The retrieved legal information may also be displayed along with an interactive image with features including, but not limited to, telephonic communication, e-mail correspondence, web browsing, and the like.

In accordance with embodiments of the present disclosure, exemplary methods for providing location-based information are provided that generally include determining a location of interest on a mobile data device. The exemplary methods generally include offering a user a plurality of categories of law or fields of law to select from on a display means of the mobile data device. Exemplary methods further generally include allowing the user to select at least one of the plurality of categories of law or fields of law and retrieving legal information based upon a selection by the user of at least one of the plurality of categories of law or fields of law and the location of interest. In addition, exemplary methods generally include displaying the retrieved legal information on the display means of the mobile data device.

Determining the location of interest can include at least one of, e.g., determining a current location of the mobile data device with a positioning system, determining the location of interest from a manual input by the user, and the like. The exemplary methods can include continuously detecting the location of interest and determining when the location of interest is a location or a jurisdiction where at least one law differs from that of a previous location. The exemplary methods can further include notifying the user of the mobile data device of alterations in the at least one law between the location of interest and the previous location. In some exemplary embodiments, rather than notifying the user of alterations in the at least one law between the location of interest and the previous location, the exemplary methods can include notifying the user of alterations in the retrieved legal information between the location of interest and the previous location. The exemplary methods can include allowing the user to select, in whole or in part, the retrieved legal information displayed on the display means. Selection by the user can further include, e.g., displaying additional information related to the selection by the user of the retrieved legal information, directing the user to an external source (e.g., a website), and the like. The exemplary methods can include creating a legal document including at least one of jurisdiction-specific language/text and language/text adhering to jurisdiction-specific formatting requirements for public recordation based on the location of interest and the selection of at least one of the plurality of categories of law or fields of law. Exemplary methods can further include providing consultation information to the user based on the location of interest and the selection of at least one of the plurality of categories of law or fields of law. The consultation information can be at least one of, e.g., a courthouse location, a plurality of defenses, a plurality of causes of action, elements for a cause of action, and the like.

In accordance with embodiments of the present disclosure, exemplary systems for providing location-based information are provided that generally include circuitry for determining a location of interest on a mobile data device. The exemplary systems generally include circuitry for offering a user a plurality of categories of law or fields of law to select from on a display means of the mobile data device. Further, exemplary systems generally include circuitry for allowing a selection by the user of at least one of the plurality of categories of law or fields of law and circuitry for retrieving legal information based upon the selection by the user of at least one of the plurality of categories of law or fields of law and the location of interest. Exemplary systems generally include circuitry for displaying the retrieved legal information on the display means of the mobile data device.

Circuitry for determining the location of interest can include at least one of, e.g., circuitry for determining a current location of the mobile data device with a positioning system, circuitry for determining the location of interest from a manual input by the user, and the like. Exemplary systems can include circuitry for continuously detecting the location of interest and circuitry for determining when the location of interest is a location or jurisdiction where at least one law differs from that of a previous location. Exemplary systems can further include circuitry for notifying the user of a mobile data device of alterations in the at least one law between the location of interest and the previous location. The exemplary systems can include circuitry for allowing the user to select, in whole or in part, the retrieved legal information displayed on the display means. Selecting the retrieved legal information can further include circuitry for, e.g., displaying additional information related to the selection by the user of the retrieved legal information, directing the user to an external source, and the like. The exemplary systems can include circuitry for creating a legal document including at least one of jurisdiction-specific language/text and language/text adhering to jurisdiction-specific formatting requirements for public recordation based on the location of interest and the selection of at least one of the plurality of categories of law or fields of law. Exemplary systems can further include circuitry for providing consultation information to the user based on the location of interest and the selection of at least one of the plurality of categories of law or fields of law. The consultation information can be at least one of, e.g., a courthouse location, a plurality of defenses, a plurality of causes of action, elements for a cause of action, and the like.

In accordance with embodiments of the present disclosure, an apparatus for providing location-based information is provided that generally includes means for determining a location of interest on a mobile data device. The exemplary apparatus generally includes means for offering a user a plurality of categories of law or fields of law to selection from on a display means of the mobile data device and means for a selection by the user of at least one of the plurality of categories of law or fields of law. Further, the exemplary apparatus generally includes means for retrieving legal information based upon the selection by the user of at least one of the categories of law or fields of law and the location of interest. Exemplary apparatuses generally include means for displaying the retrieved legal information on the display means of the mobile data device.

Means for determining the location of interest can include at least one of, e.g., a positioning system for determining a current location of the mobile data device, a manual input by the user of the location of interest, and the like. Exemplary apparatuses can include means for continuously detecting the location of interest and means for determining when the location of interest is a location or a jurisdiction where at least one law differs from that of a previous location. Further, exemplary apparatuses can include means for notifying the user of the mobile data device of alterations in the at least one law between the location of interest and the previous location. Exemplary apparatuses can include means for allowing the user to select, in whole or in part, the retrieved legal information displayed on the display means. Based on the selection of the retrieved legal information, exemplary apparatuses can include, e.g., means for displaying additional information related to the selection by the user of the retrieved legal information, means for directing the user to an external source, and the like. The exemplary apparatuses can include means for creating a legal document including at least one of jurisdiction-specific language/text and language/text adhering to jurisdiction-specific formatting requirements for public recordation based on the location of interest and the selection of at least one of the plurality of categories of law or fields of law. Exemplary apparatuses can further include means for providing consultation information to the user based on the location of interest and the selection of at least one of the plurality of categories of law or fields of law. The consultation information can be at least one of, e.g., a courthouse location, a plurality of defenses, a plurality of causes of action, elements for a cause of action, and the like.

In accordance with embodiments of the present disclosure, exemplary computer program products on an electronically discernible medium for providing location-based information are provided that generally include instructions for determining a location of interest on a mobile data device. The exemplary computer program products generally include instructions for offering a user a plurality of categories of law or fields of law to select from on a display means of the mobile data device and instructions for allowing a selection by the user of at least one of the plurality of categories of law or fields of law. The exemplary computer program products generally further include instructions for displaying the retrieved legal information on the display means of the mobile data device.

Instructions for determining the location of interest can include at least one of, e.g., instructions for determining a current location of the mobile data device with a positioning system, instructions for determining the location of interest from a manual input by the user, and the like. The exemplary computer program products can include instructions for continuously detecting the location of interest and instructions for determining when the location of interest is a location or a jurisdiction where at least one law differs from that of a previous location. Exemplary computer program products can include instructions for notifying the user of the mobile data device of alterations in the at least one law between the location of interest and the previous location. Further, exemplary computer program products can include instructions for allowing the user to select, in whole or in part, the retrieved legal information displayed on the display means. Based on the selection, exemplary computer program products can include, e.g., instructions for displaying additional information related to the selection by the user of the retrieved legal information, instructions for directing the user to an external source, and the like. The exemplary computer program products can include instructions for creating a legal document including at least one of jurisdiction-specific language/text and language/text adhering to jurisdiction-specific formatting requirements for public recordation based on the location of interest and the selection of at least one of the plurality of categories of law or fields of law. Exemplary computer program products can further include means for providing consultation information to the user based on the location of interest and the selection of at least one of the plurality of categories of law or fields of law. The consultation information can be at least one of, e.g., a courthouse location, a plurality of defenses, a plurality of causes of action, elements for a cause of action, and the like.

In accordance with embodiments of the present disclosure, exemplary methods for displaying an advertisement, an image and/or associated interactive features on a mobile data device are provided that generally include determining a location of interest on the mobile data device. The exemplary methods generally include offering a user a plurality of categories of law or fields of law to select from on a display means of the mobile data device and allowing the user to select at least one of the plurality of categories of law or fields of law. Exemplary methods can include retrieving at least one of the advertisement, the image, and the associated interactive features based upon a selection by the user of at least one of the plurality of categories of law or fields of law and the location of interest. Further, exemplary methods can include displaying at least one of the advertisement, the image, and the associated interactive features on the display means of the mobile data device.

Determining the location of interest can include at least one of, e.g., determining a current location of the mobile data device with a positioning system, determining the location of interest from a manual input by the user, and the like. Exemplary methods can include allowing the user to communicate with a party associated with at least one of the advertisement, the image, and the associated interactive features by selecting at least one of the advertisement, the image, and the associated interactive features. In addition, exemplary methods can include allowing the user to browse a website of a party associated with at least one of the advertisement, the image, and the associated interactive features by selecting at least one of the advertisement, the image, and the associated interactive features.

In accordance with embodiments of the present disclosure, exemplary systems for displaying an advertisement, an image and/or associated interactive features on a mobile data device are provided that generally include circuitry for determining a location of interest on the mobile data device. Exemplary systems generally include circuitry for offering a user a plurality of categories of law or fields of law to select from on a display means of the mobile data device and circuitry for allowing a selection by the user of at least one of the plurality of categories of law or fields of law. The exemplary systems generally include circuitry for retrieving at least one of the advertisement, the image, and the associated interactive features based upon the selection by the user of at least one of the plurality of categories of law or fields of law and the location of interest. Further, exemplary systems generally include circuitry for displaying at least one of the advertisement, the image, and the associated interactive features on the display means of the mobile data device.

Circuitry for determining the location of interest can include at least one of, e.g., circuitry for determining a current location of the mobile data device with a positioning system, circuitry for determining the location of interest from a manual input by the user, and the like. The exemplary systems can include circuitry for allowing the user to communicate with a party associated with at least one of the advertisement, the image, and the associated interactive features by selecting at least one of the advertisement, the image, and the associated interactive features. Exemplary systems can include circuitry for allowing the user to browse a website of a party associated with at least one of the advertisement, the image, and the associated interactive features by selecting at least one of the advertisement, the image, and the associated interactive features.

In accordance with embodiments of the present disclosure, exemplary apparatuses for displaying an advertisement, an image and/or associated interactive features are provided that generally include means for determining a location of interest on a mobile data device. The exemplary apparatuses generally include means for offering a user a plurality of categories of law or fields of law to select from on a display means of the mobile data device and means for allowing a selection by the user of at least one of the plurality of categories of law or fields of law. Exemplary apparatuses generally include means for retrieving at least one of the advertisement, the image, and the associated interactive features based upon the selection by the user of at least one of the plurality of categories of law or fields of law and the location of interest. Further, the exemplary apparatuses generally include means for displaying at least one of the advertisement, the image, and the associated interactive features on the display means for the mobile data device.

Means for determining the location of interest can include at least one of, e.g., a positioning system for determining a current location of the mobile data device, a manual input by the user of the location of interest, and the like. Exemplary apparatuses can include means for allowing the user to communicate with a party associated with at least one of the advertisement, the image, and the associated interactive features by selecting at least one of the advertisement, the image, and the associated interactive features. Further, the exemplary apparatuses can include means for allowing the user to brose a website of a party associated with at least one of the advertisement, the image, and the associated interactive features by selecting at least one of the advertisement, the image, and the associated interactive features.

In accordance with embodiments of the present disclosure, exemplary computer program products on an electronically discernible medium for displaying an advertisement, an image and/or associated interactive features on a mobile data device are provided that generally include instructions for determining a location of interest on the mobile data device. Exemplary computer program products generally include instructions for offering a user a plurality of categories of law or fields of law to select from on a display means of the mobile data device and instructions for allowing a selection by the user of at least one of the plurality of categories of law or fields of law. Further, the exemplary computer program products can include instructions for retrieving at least one of the advertisement, the image, and the associated interactive features based upon the selection by the user of at least one of the plurality of categories of law or fields of law and the location of interest. Exemplary computer program products generally include instructions for displaying at least one of the advertisement, the image, and the associated interactive features on the display means of the mobile data device.

Instructions for determining the location of interest can include at least one of, e.g., instructions for determining a current location of the mobile data device with a positioning system, instructions for determining the location of interest from a manual input by the user, and the like. Exemplary computer program products can include instructions for allowing the user to communicate with a party associated with at least one of the advertisement, the image, and the associated interactive features by selecting at least one of the advertisement, the image, and the associated interactive features. Further, exemplary computer program products can include instructions for allowing the user to browse a website of a party associated with at least one of the advertisement, the image, and the associated interactive features by selecting at least one of the advertisement, the image, and the associated interactive features.

Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

To assist those of skill in the art in making and using the disclosed methods and systems, reference is made to the accompanying figures, wherein:

FIGS. 1A and 1B illustrate (i) a wireless communication and computer network system that implements one or multiple exemplary systems and methods, and (ii) a block diagram of exemplary components of a mobile data device with geolocation technology that is utilized in the network of FIG. 1A;

FIGS. 2A and 2B illustrate (i) a block diagram of an exemplary computing device configured to implement embodiments of exemplary systems and methods, and (ii) a computing system for implementing embodiments of exemplary systems and methods;

FIG. 3 is a block diagram of an exemplary organization of components utilized with FIGS. 1A and 1B that implements one or more exemplary systems and methods;

FIGS. 4A-4D illustrate (i) an exemplary process for displaying legal information based on geolocation technology and a user's selection of at least one category of law or field of law, (ii) an exemplary process for displaying legal information based on a user's selection of a location or jurisdiction and a user's selection of at least one category of law or field of law, (iii) an exemplary process for displaying an advertisement or an image based on geolocation technology and a user's selection of at least one category of law or field of law, and (iv) an exemplary process for displaying an advertisement or an image based on a user's selection of a location or jurisdiction and a user's selection of at least one category of law or field of law;

FIG. 5 illustrates an exemplary graphical user interface for determination of a location of interest;

FIG. 6 illustrates an exemplary graphical user interface for selection of a location of interest;

FIG. 7 illustrates exemplary menus and submenus of an exemplary system; and

FIG. 8 illustrates an exemplary graphical user interface for an advertisement.

### DESCRIPTION OF EXEMPLARY EMBODIMENTS

Embodiments are directed to an exemplary location-based mobile network system that distributes legal information and/or advertisements or images based on categories of law or fields of law and based on a location of interest, e.g., a current location determined by a positioning system or geolocation technology, a location determined by a manual user input, and the like. In exemplary embodiments implementing a positioning system or geolocation technology, a mobile data device user's jurisdiction can be instantaneously deduced and information tailored to that jurisdiction can be displayed on the mobile data device without requiring a citizen to input additional information. The following description provides a thorough understanding of, and enabling description for, embodiments of the exemplary system. An individual skilled in the relevant art may recognize that the particular embodiments contained herein may be practiced without one or more of the specific details, or with other related components, systems, and the like. Additionally, structures or operations that are well known to those skilled in the relevant art are not depicted or described in detail so that these structures or operations do not obscure aspects of the disclosed embodiments.

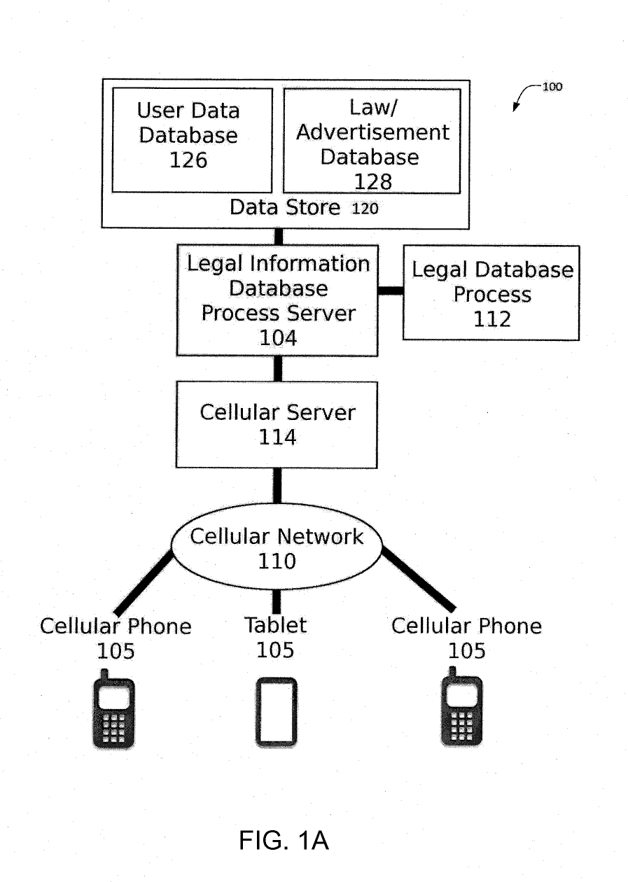

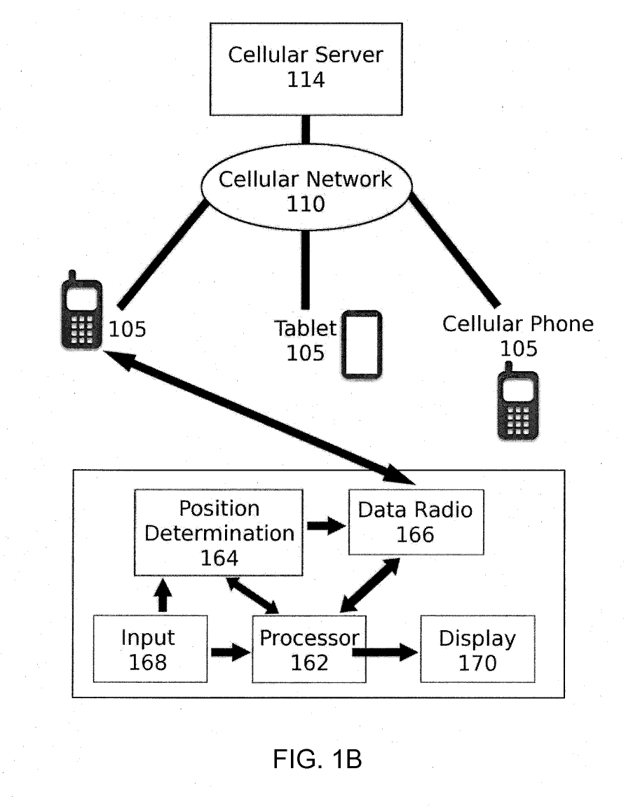

FIG. 1A illustrates a communication and computer network system 100 that implements one or more exemplary systems and methods. Exemplary system 100 generally includes a plurality of mobile data devices 105, e.g., cell phones, wireless tablet devices, and the like, coupled to a communication network 110, e.g., a cellular network, and the like. The mobile data devices 105 can be carried and operated by a user and communicate with the cell network 110 using known communication methods, such as wireless telephony, radio, satellite, cellular systems, or other similar methods. Although the mobile data devices 105 illustrated in FIG. 1A are cellular phones or tablets and the communication network 110 coupling these devices is a cellular telephone network, it should be understood that any other type of wireless network that supports mobile data devices 105 can also be utilized.

In one exemplary embodiment, a legal information database process server 104, e.g., a server computer, can run a location-based legal information database process 112. The legal information database process 112 generally controls various data objects relating to one or more category of law or field of law selections provided by the user. In particular, legal database process 112 generally retrieves information stored in a database related to a user's location and selection of law. Further, the legal database process 112 can make the information available to process server 104. The process server 104, which processes requests for legal information, can be programmed to collect relevant data and store it in an appropriate user data database 126. The process server 104 can further collect data relating to the jurisdiction, i.e., the location of interest, determined by a positioning system or manually selected by a user and the category of law or field of law selected by the user. The jurisdiction and the category or field of law can be used for a variety of purposes including, but not limited to: (i) providing legal information based on the jurisdiction; (ii) calculating the probability of a particular legal problem in a geographic location; (iii) calculating the probability a particular user is vulnerable to a particular legal problem; (iv) providing information to a user regarding an elevated statistical risk of a legal issue as it pertains to a user and location; (v) creating a jurisdiction-specific template of a variety of legal documents; and (vi) providing consultation information, e.g., the nearest courthouse, defenses for the category or field of law, causes of action for the category or field of law, and the like. The above information may be shared with the user on the mobile data device 105 such that potential legal issues may be preempted and/or proper legal action can be taken.

Since users of mobile data devices 105 are inherently transitory, a data object associated with each of the users of the mobile data devices 105 can be the location of each user within a particular region. A user who retrieves information from the database 126 regarding a category of law or field of law based on location or jurisdiction utilizes the legal database process 112. Through continued use of the system 100, each user registers information with the process server 104. All data specific to a user and data regarding users in the aggregate can be stored in one or more databases accessible to the server computer 104. In the exemplary embodiment of FIG. 1A, the data objects related to the user and users in the aggregate can be stored in a data store 120 and can be further organized in a user data database 126 and a law/advertisement database 128. The user data database 126 can include data generated by the plurality of users, while the law/advertisement database 128 can include data relating to laws of various jurisdictions and/or advertising information. The communications network 110 supporting the mobile data devices 105 can be coupled to the process server 104 through an intermediate server computer, such as cellular server 114.

As shown in FIG. 1A, aspects of the one or more embodiments described herein may be implemented on one or more computing devices executing software instructions. The process server 104, i.e., the server computer, can be a server or workstation class computer or any type of computing device with sufficient power and resources. The mobile data devices 105 can be, e.g., a mobile computing device, such as a mobile phone, a personal digital assistant (PDA), a notebook computer, a game console, a wireless tablet device, or any similar class of mobile computing device with sufficient processing and communication capability to interact with other devices over network 110.

In an exemplary embodiment, the legal database process 112 can contain one or more program components that perform the tasks of, e.g., providing geocoded legal information, providing geocoded customized legal documents, providing geocoded advertisements or geocoded images, determining statistics based on user data which can be used to predict the legal tendencies of a location, communicating information to the mobile data devices 105, and the like. The process can also include a database manager program that manages the different databases stored in data store 120. It should be noted that the various databases 126, 128 shown in data store 120 may be organized as separate databases, portions of a single database, or any other logical structure appropriate for storing the data. Real-time location information for each user can be stored in the user data database 126, i.e., a location database, and geo-tagged legal information, advertisements and/or images can be stored in the law/advertisement database 128. The legal information, advertisements and/or images generally correspond to an area, region or jurisdiction.

FIG. 1B is a block diagram of components of an exemplary location-aware mobile device, i.e., a mobile data device 105, that is used in the exemplary network of FIG. 1A. Mobile data device 105 represents a mobile phone or similar mobile data device that can provide a user location of interest to a cellular network 110 by a positioning system and/or through a manual input by a user. In particular, the location of interest information for the mobile data device can be determined by a position determination unit 164, such as a Global Positioning System (GPS) method, or other location determination process implemented within the device 105, or by a user input 168. The location provided by a positioning system can be the current location of the user, i.e., the current location of the mobile data device 105, while the location provided by the manual input by the user can be any location desired by the user. The location information can be provided in a standardized format, such as city and state, to a processor 162 and a data radio 166. The location specified by the user or detected by the positioning system in the mobile data device 105 can further be shared with the legal database process 112 and/or the process server 104, e.g., computers, and the like, as seen in FIG. 1A.

Once a location of interest has been determined, a user utilizing the mobile data device 105 can be required to choose a category of law or field of law using the input device 168, e.g., a drop-down menu of a plurality of categories of law or fields of law. In some exemplary embodiments, the user may be required to initially choose a broad category of law or field of law and subsequently choose a narrower category of law or field of law based on the initial selection. The choice of a category of law or field of law can be provided to a processor 162 and a data radio 164. The information can further be sent or shared with the legal database process 112 and/or the process server 104, as seen in FIG. 1A, to retrieve legal information relevant to the location of interest and the category of law or field of law selected. In particular, the location-based legal information database process 112 executed by process server 104 can return the relevant legal information data for display on a mobile device display screen 170. In additional to the display of relevant legal information, the database process 112 can further display advertisements and/or images from the law/advertisement database 128 based on the location data and the selection of a category of law or field of law on the user's mobile data device 105.

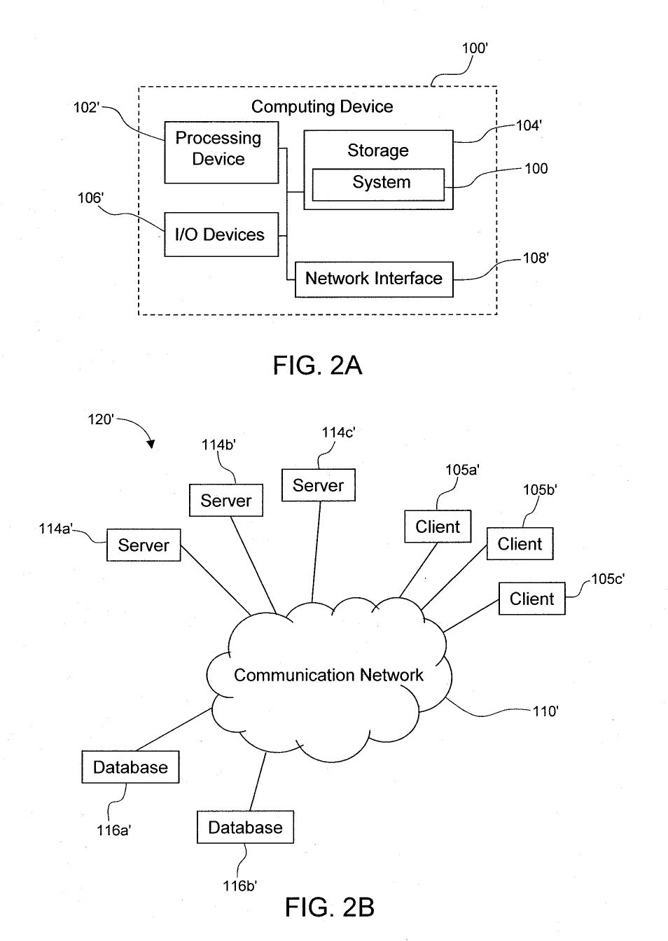

FIG. 2A is a block diagram of an exemplary computing device 100′ configured to implement some embodiments of the system 100. The computing device 100′ can be a mainframe, personal computer (PC), laptop computer, workstation, server, handheld device, such as a portable digital assistant (PDA), a cell phone, and the like. In the illustrated embodiment, the computing device 100′ includes a processing device 102′, such as a central processing unit, and can include storage 104′. The computing device 100′ can further include input/output devices 106′, such as a display device, keyboard, touch screen, mouse, printer, and the like, and can include a network interface 108′ to facilitate communication between the computing device 100′ and other devices communicatively coupled to a network.

The storage 104′ stores data and instructions and can be implemented using non-transitory computer readable medium technologies, such as a floppy drive, hard drive, tape drive, solid state storage devices, Flash drive, optical drive, read only memory (ROM), random access memory (RAM), and the like. For example, the storage 104′ can store user information, location information, legal information, advertisement information, image information, and the like. Applications, such as an embodiment of the system 100, or portions thereof, can be resident in the storage 104′ and can include instructions for implementing the applications. The storage 104′ can be local or remote to the computing device 100′. The processing device 102′ operates to execute the applications in storage 104′, such as the system 100, by executing instructions therein and storing data resulting from the executed instructions, which may be presented via, for example, a graphical user interface (GUI) on a mobile data device 105.

FIG. 2B is a block diagram of an exemplary computing system 120′ configured to implement one or more embodiments of the system 100. The computing system 120′ includes servers 114a′, 114b′, 114c′ operatively coupled to clients 105a′, 105b′, 105c′, i.e., mobile data devices 105, via a communication network 110′, which can be any network over which information can be transmitted between devices communicatively coupled to the network. For example, the communication network 110′ can be the Internet, Intranet, virtual private network (VPN), wide area network (WAN), local area network (LAN), a cellular network 110, and the like. The computing system 120′ can include repositories or database devices 116a′, 116b′, e.g., a user information database, a legal information database, an advertisement database, an image database, and the like, which can be operatively coupled to the servers 114a′, 114b′, 114c′, as well as to clients 105a′, 105b′, 105c′, via the communications network 110′. The servers 114a′, 114b′, 114c′, clients 105a′, 105b′, 105c′, and database devices 116a′, 116b′, can be implemented as computing devices. Those skilled in the art will recognize that the database devices 116a′, 116b′ can be incorporated into one or more of the servers 114a′, 114b′, 114c′ such that one or more of the servers 114a′, 114b′, 114c′ can include databases 116a′, 116b′. In exemplary embodiments, the system 100 can be distributed among different devices (e.g., servers, clients, databases) in the communication network 110′ such that one or more components of the system 100, or portions thereof, can be implemented by different devices in the communication network 110′.

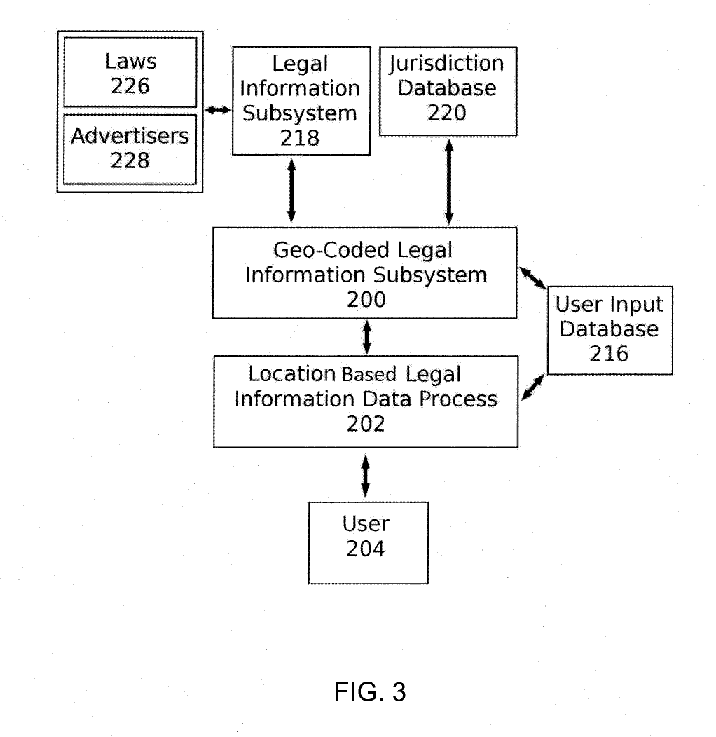

With reference now to FIG. 3, a block diagram is provided of an organization of exemplary system components in the location-based legal information database discussed with respect to FIGS. 1A and 1B. It should be understood that the selection and connections of components are merely illustrative of the data stores and functionality that may be required in a given embodiment. Other exemplary embodiments may include fewer or additional data stores or components as necessary to provide the desired functionality in a given embodiment of the present invention.

The location-based legal information data process 202 (hereinafter “LBLIDP 202”), e.g., at least one server, can be utilized in conjunction with a geocoded legal information subsystem 200, which coordinates the compilation, storage, and/or retrieval of various forms of information, as is described in more detail below. The LBLIDP 202 can interact with the geocoded legal information subsystem 200 to retrieve information from and/or to the users of the location-based legal information service. The LBLIDP 202 may be similar to the server devices described above with respect to FIGS. 1A and 1B.

Each user generally has a mobile data device 105 that acts as a client device to LBLIDP 202. The mobile data devices 105 are shown as users 204 in FIG. 3 and may be substantially similar to the mobile data devices 105 described above with respect to FIGS. 1A and 1B. User clients 204 generally receive legal information from the service based on a location of interest, e.g., the location of the mobile data device as determined by a positioning system, a location selected manually by a user, and the like, and a user selection of a category of law or field of law, as described in more detail further below.

As the mobile data device of a user 204 moves from location to location, LBLIDP 202 can receive an input from a subsystem, i.e., a user input database 216, which logs data for a user relating to geographic location of the user 204, a geographic location manually input by a user 204, and/or a choice of a category of law or field of law. Subsystem 216 can utilize exemplary probability algorithms to determine a statistically elevated level of a risk for a problem with a category of law in a particular area. Further the system can utilize the data regarding a choice by a user of a category of law or field of law to determine if the user has a statistically elevated vulnerability to confronting a legal problem in an area of law. This data can be utilized to provide information to LBLIDP 202 to provide appropriate information to the end user 204, e.g., a warning of an elevated risk in a selected category of law, and the like.

As an example, a person who consistently exceeds the speed limit while driving a motor vehicle may be more likely to check the speed limit in each jurisdiction they enter. As the user utilizes the exemplary system, the system may employ statistical processes to identify the user as a person who may benefit from information regarding how strictly a jurisdiction enforces speeding laws.

The exemplary system may also utilize data to compare jurisdictions. For example, jurisdiction A may have a policy of issuing tickets to those traveling three (3) miles over the speed limit. On the other hand, jurisdiction B may have a policy of not issuing tickets unless a person is traveling at least eight (8) miles over the speed limit. Assuming jurisdictions A and B have substantially equal populations and the populations have similar driving habits, the exemplary system would likely see greater activity regarding user selection of speeding laws in jurisdiction B. As such, the exemplary system can process this information and identify jurisdiction B as a jurisdiction that strictly enforces its speeding laws. The exemplary system may further be implemented to warn a user that the system has identified the user as a person who would benefit from the knowledge that jurisdiction B strictly enforces its speeding laws when the user enters jurisdiction B.

Geocoded legal information subsystem 200 can receive information from LBLIDP 202 regarding the user's location and/or category of law or field of law. Using this information, the legal information subsystem 218 can retrieve information from a plurality of databases, e.g., a law database 226, an advertiser database 228, and the like, to provide geocoded legal information and/or a correlating interactive advertisement or image to the geocoded legal information subsystem 200. The geocoded legal information subsystem 200 can in turn provide the legal information and/or the advertisement information to LBLIDP 202, which then provides the information for display to user 204 on a graphical user interface of the mobile data device 105.

As would be understood by those of ordinary skill in the art, the law database 226 can include laws compiled and/or updated by third party vendors, extrapolated from internet sources in an automated fashion by a process of the legal information subsystem 218, compiled and stored by manual input, or other similar methods. In an exemplary embodiment, the law database 226 can be accessible via a web interface such that the laws can be organized by a human. In some exemplary embodiments, the legal information can also be updated via a web interface.

The advertiser database 228 can be compiled, organized, and/or updated by human input, automatically via advertiser submission on a designated website, or other similar methods. In an exemplary embodiment, the advertiser database 228 can be accessible via a web interface such that the advertisers and advertiser information can be organized by human input. In some exemplary embodiments, the advertisements can also be updated via a web interface.

In accordance with an exemplary embodiment of the legal information service as described herein, a user and/or subscriber may roam around a particular geographic region with a mobile data device 105. The user can be provided with an option to, e.g., manually select/input a location of interest, manually select/input a current location, input a current location through a positioning system, and the like. The user can then be provided with an option to select at least one category of law or field of law. In some exemplary embodiments, a “drop-down” menu may be provided such that a user is initially permitted to select a category of law or field of law from a broad selection of categories of law or fields of law and a further selection may be provided as an option to narrow down the category of law or field of law selected. Once the location of interest and the category of law or field of law has been selected, the system can presents legal information relevant to the location of interest and the category of law or field of law to the user.

The exemplary location-based legal information service can also log the request for specific categories of law or fields of law as selected by a user over time. The location-based legal information service can maintain metadata regarding a user and can further utilize statistics gathered from the aggregate of all users implementing the system to predict an elevated risk of a problem with an area of law in a geographic location. As discussed above, the exemplary location-based legal information service can thus implement the statistical information to determine when a particular user could benefit from a warning regarding an elevated risk of a problem with a selected area of law.

In additional to the retrieval of legal information related to the geographical location and/or the selected category of law or field of law, the mobile data device 105 can receive appropriate advertisements, images, and/or warning from LBLIDP 202. Geocoded legal information subsystem 200 create, access, and/or maintain a plurality of databases as may be necessary to perform its functions. In general, these databases may be created prior to actively tracking and servicing users. A geocoded jurisdiction database 220 can include geospatial information about jurisdictions, such as the geospatial boundaries of municipal, state, and federal jurisdictions, the location of courthouses, and other legal bodies or entities. In some exemplary embodiments, this information may be manually entered and/or updated in the jurisdiction database 220.

Law database 226 can contain information on the different laws based on jurisdictions and separated by categories of law or fields of law. The law database 226 can further include legal information such as, e.g., jurisdiction-specific language/text necessary for the creation of legal documents, jurisdiction-specific language/text adhering to jurisdiction-specific formatting requirements for public recordation, causes of action specific to a jurisdiction, elements required to be shown in court for proof of a cause of action, defenses specific to a jurisdiction, affirmative defenses, and the like. For example, the jurisdiction-specific language in the law database 226 can be utilized to create templates of legal documents, e.g., a will, a complaint, an answer, and the like, based on the location of interest and the category of law or field of law. By recognizing the jurisdiction of interest, the exemplary system can compile the jurisdiction-specific language into a template to create a plurality of legal documents requested by a user, e.g., a will, a contract, a non-disclosure agreement, and the like.

Furthermore, by allowing for user input and retrieval of legal information stored in the law database 226, e.g., a subsystem or similar systems, the LBLIDP 202 may have the capability to create geocoded customized legal documents through, e.g., executing software programs with text and/or editing functions, and the like. For example, the LBLIDP 202 may create geocoded customized legal documents by retrieving legal text stored in law database 226. The legal text may have specific legal effects in the particular jurisdiction of interest. The retrieved legal text can be incorporated into a legal document and saved as an end product. The user may further input additional information and/or edit the customized legal document created. As would be understood by those of ordinary skill in the art, the legal text selected for the customized legal documents based on jurisdiction generally produces different effects due to the varying laws in different jurisdictional boundaries, e.g., states, countries, treaty associates, and the like.

For example, a user may desire to devise a particular gold watch to an eldest son upon the user's death through a trust or to all of the user's heirs rather than the eldest son's heirs in the event that the eldest son is not alive at the time of the user's death. In the majority of states, a party must only place text such as “I devise my gold watch to my eldest son, if he survives” to produce the desired effect, i.e., to negate the interpretative effect of an anti-lapse statute. However, in the state of Connecticut in the United States, use of the prior phrase will result in the eldest son's heirs taking the gold watch if the eldest son is not alive at the time of the user's death. In particular, a party in Connecticut must specifically designate a successor beneficiary by using text such as “I devise my gold watch to my eldest son, if he survives, otherwise to my heirs” to produce the desired effect. As such, the exemplary system can recognize the necessity for specific legal language based on the user's intent and the jurisdiction of interest, thereby implementing the proper language in the customized legal document.

In addition, some legal documents, e.g., deeds, must be recorded in the public records. However, the specifications for recording documents may vary among jurisdictions. For example, different jurisdictions may require specific minimum margins, particular titles, and the like. The LBLIDP 202 of the exemplary system can therefore retrieve the legal language stored specifically for a jurisdiction and can further adhere to the particular specifications, e.g., recording specifications, of the relevant jurisdiction.

The advertiser database 228 can contain a geocoded index of advertisers organized by a category of law or field of law practiced. The geocoded index of advertisers can include contact information regarding contacting the advertisers, e.g., an address, a telephone number, an e-mail address, a fax number, a website, and the like. The advertiser database 228 can provide the contact information such that an interactive advertisement and/or image can be displayed on the user's mobile data device 105 when the desired legal information is retrieved. In some exemplary embodiments, an interactive advertisement can be provided. The user can thereby be provided with an option for contacting the party issuing the advertisement to discuss the category of law or field of law of interest in the particular jurisdiction.

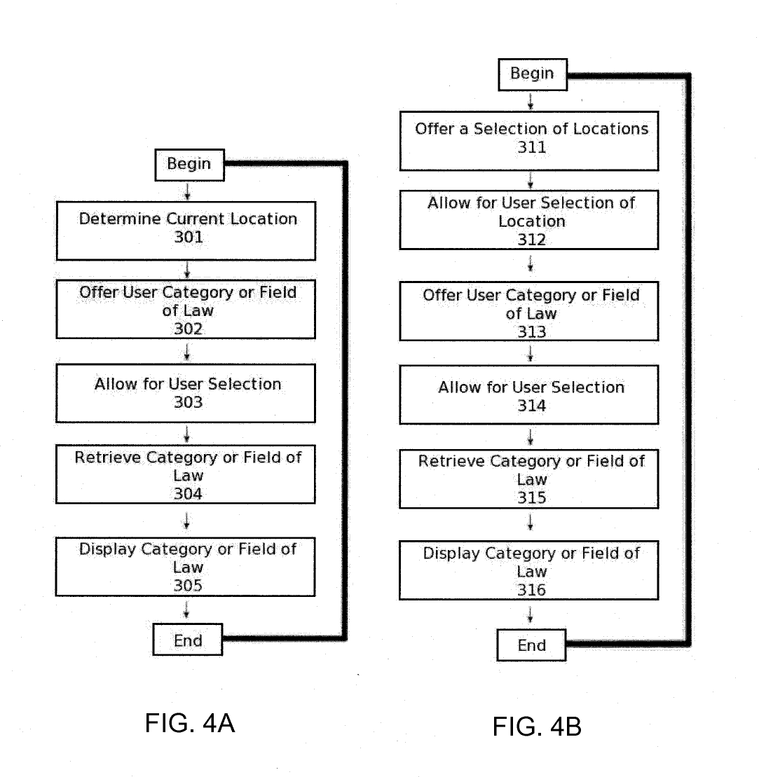

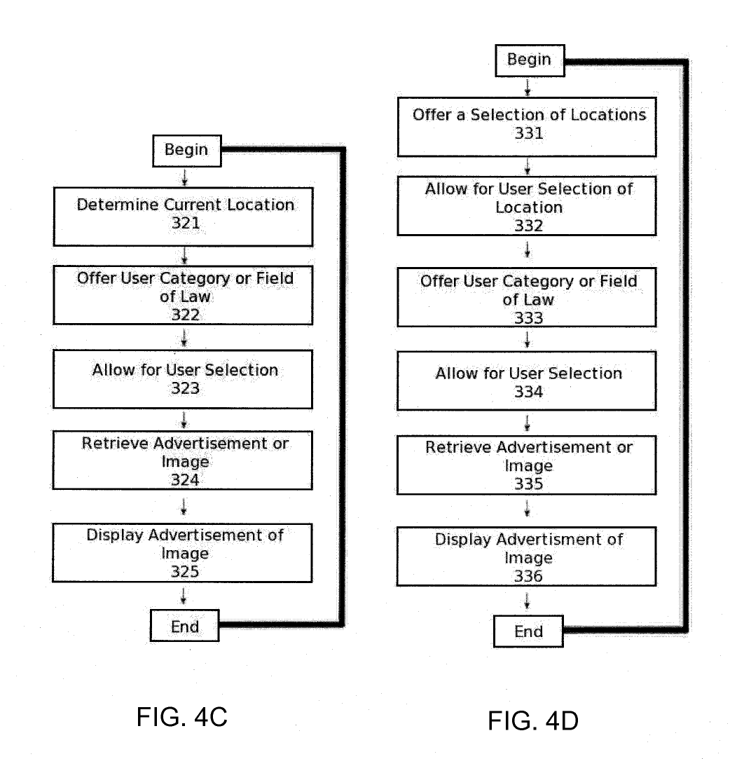

Turning now to FIG. 4A, a flowchart is provided that illustrates an exemplary process for displaying relevant legal information on a user's mobile data device 105. The process can utilize geolocation technology and/or user input to display the relevant legal information. In the exemplary embodiment of FIG. 4A, the system can initially determine the current location of a user's mobile data device 105 through a positioning system and/or geolocation technology (301). After a particular location or jurisdiction has been determined, a user can be offered a variety of categories of law or fields of law to select from on a display means of a mobile data device 105 (302). Categories of law or fields of law can generally refer to distinguishing between the applicable laws, not as a process to distinguish the interests of individual users. The categories of law or fields of law may be described by traditional terms (such as “tort”, “constitutional”, or “property”), through more colloquial descriptions so as to assist a user (such as “police interaction” or “traffic accidents”), and/or with particular causes of action (such as “breach of contract” or “tortuous interference with contractual relations”).

The exemplary process of FIG. 4A generally continues by allowing a user to select a particular category of law or field of law (303). It is implicit that a user will select a particular category of law or field of law such that the user can learn more about the particular subject matter. Once a user makes a selection, the application can retrieve the relevant legal information based on the current location of the mobile data device 105 and the user's selection of a particular category of law or field of law (304). The retrieved relevant legal information, as determined by the current location of the mobile data device 105 and the user's selection of a category of law or field of law, can be displayed on a display means of a mobile data device 105 (305). The legal information displayed may also include information regarding how or where to file a claim or cause of action, e.g., a courthouse, an administrative entity, and the like, and/or associated evidentiary rules as related to the determined current location of the mobile data device 105 and the user's selection of a category of law or field of law. In some exemplary embodiments, in additional to the retrieved legal information, applicable advertisements for, e.g., legal consultants, attorneys, and the like, who offer services in the jurisdiction for the determined category of law or field of law, may also be provided.

FIG. 4B is a flowchart that illustrates an exemplary process for displaying relevant legal information on a user's mobile data device 105. The exemplary process generally utilizes a manual user input to determine a particular location or jurisdiction, rather than a process that utilizes a positioning system and/or geolocation technology as described in FIG. 4A. However, it should be understood that once a manual user input regarding a location of interest has been obtained, in some exemplary embodiments, a positioning system and/or geolocation technology may be implemented to monitor the movement of the user such that a change in jurisdiction can notify the user of any relevant changes in legal information. The exemplary process illustrated in FIG. 4B can initiate by offering a user a selection of locations and/or jurisdictions on a display means of a mobile data device 105, e.g., a graphical user interface, and the like (311). The selection of a location and/or jurisdiction displayed may include, but is not limited to, locations or jurisdictions categorized nationally, regionally, by state, by county, by city, or by any combination thereof. After a user has been offered a selection of locations and/or jurisdictions, the system can allows a user to select a particular location or jurisdiction of interest (312). It is implicit that a user will generally select a particular location or jurisdiction such that the user can learn more about the law from that particular location or jurisdiction. It should also be understood that the location or jurisdiction manually selected by the user can be the current location of the user or an alternative location of interest.

After a user has selected a particular location or jurisdiction, a user can be offered a variety of categories of law or fields or law to select from on a display means of a mobile data device 105 (313). Thereafter, a user can be allowed to select a particular category of law or field of law (314). Once a user has made a selection regarding a category of law or field of law, the application can retrieve the relevant legal information based on the user's selection of a particular location or jurisdiction and the user's selection of a particular category of law or field of law (315). In some exemplary embodiments, once an initial selection of a category of law or field of law has been made by the user, the system may provide means for selecting a narrower category of law or field of law based on the initial selection to retrieve more specific legal information. The retrieved relevant legal information, as determined by the particular location selected by the user and the user's selection of a category of law or field of law, can be displayed on a display means of a mobile data device 105 (316). The legal information displayed may also include information regarding how or where to file a claim or cause of action, such as at a courthouse or with an administrative entity, and/or associated evidentiary rules as related to the location selected by the user and the user's selection of a category of law or field of law. In some exemplary embodiments, in additional to the retrieved legal information, applicable advertisements for, e.g., legal consultants, attorneys, and the like, who offer services in the selected jurisdiction and category of law or field of law, may also be provided.

FIG. 4C is a flowchart illustrating an exemplary process for displaying an advertisement and/or an image on a mobile data device 105. The exemplary process generally utilizes a positioning system and/or geolocation technology and user input to display an advertisement and/or an image. In the exemplary process of FIG. 4C, the system can determine the current location of a user's mobile data device 105 through a positioning system and/or geolocation technology (321). After a particular location or jurisdiction has been determined, a user can be offered a variety of categories of law or fields or law to select from on a display means of a mobile data device 105 (322). Thereafter, the system can allow a user to select a particular category of law or field of law (323). Once a user has made a selection, the system can retrieve an advertisement and/or an image based on the current location of the mobile data device 105 and the user's selection of a particular category of law or field of law (324). The retrieved advertisement and/or image, as determined by the current location of the mobile data device 105 and the user's selection of a category of law or field of law, can further be displayed on a display means of a mobile data device 105 (325). In some exemplary embodiments, in addition to the retrieved advertisement and/or image, legal information related to the determined jurisdiction and category of law or field of law may also be provided.

FIG. 4D is a flowchart depicting an exemplary process for displaying an advertisement and/or an image on a user's mobile data device 105. The process generally utilizes a manual user input to determine a particular location or jurisdiction, rather than a process that utilizes a positioning system and/or geolocation technology as described in FIG. 4A and 4C. The exemplary process of FIG. 4D can initiate by offering a user a selection of locations and/or jurisdictions on a display means of a mobile data device 105 (331). After a user has been offered a selection of locations or jurisdictions, the system can allow a user to select a particular location or jurisdiction of interest (332). After a user has selected a particular location or jurisdiction, a user can be offered a variety of categories of law or fields or law to select from on a display means of a mobile data device 105 (333). The process can then allow a user to select a particular category of law or field of law (step 334). Once a user has made a selection regarding a category of law or field of law, the system can retrieve an advertisement and/or an image based on the user's selection of a particular location or jurisdiction and the user's selection of a particular category of law or field of law (335). The retrieved advertisement and/or image, as determined by the user's selection of a particular location or jurisdiction and the user's selection of a category of law or field of law, can further be displayed on a display means of a mobile data device 105 (336). In some exemplary embodiments, in addition to the retrieved advertisement and/or image, legal information related to the selected jurisdiction and category of law or field of law may also be provided.

As would be understood by those of ordinary skill in the art, the exemplary processes described in FIGS. 4A-4D may be, e.g., manually repeated by additional user input, automatically repeated based on monitoring of a change in user location, and the like. In addition to the processes described in FIGS. 4A-4D, the exemplary systems can include the steps of creating legal documents including jurisdiction-specific language and/or providing consultation information based on the selection or determination of a location of interest and the selection by the user of a category of law or field of law.

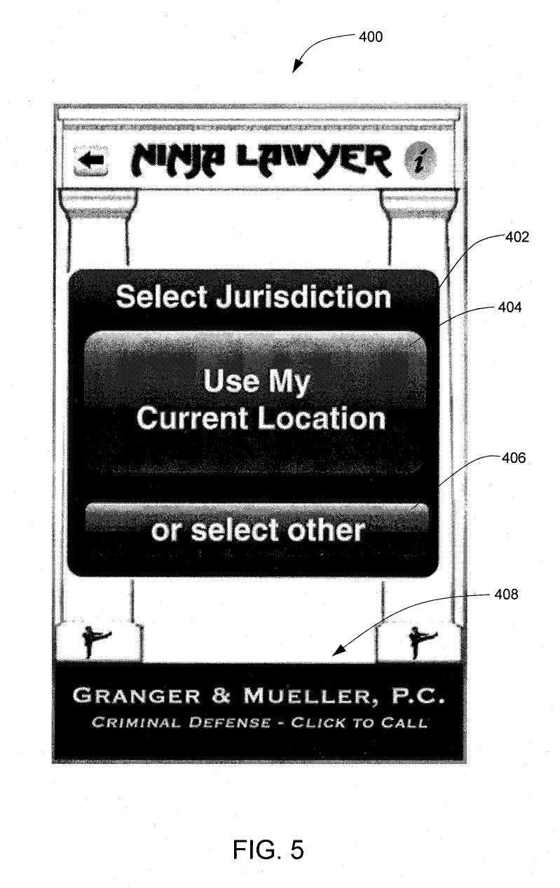

With reference to FIG. 5, an exemplary graphical user interface 400 for determination of a location of interest is provided. In particular, the graphical user interface 400 generally includes a jurisdiction menu title 402, a current location selection 404, and an alternative location selection 406. As described above, the current location selection 404 can implement a positioning system or geolocation technology to determine the current location of the mobile data device, i.e., the current location of the user. A user can also manually select a location of interest by implementing the alternative location selection 406. By selecting the alternative location selection 406, the user can be directed to select, e.g., a country, a state, a city, a county, and the like, through menus and submenus. The graphical user interface 400 can also include an advertisement section 408 which can display general advertisements and/or advertisements specific to the location of interest and/or a selected category of law or field of law.

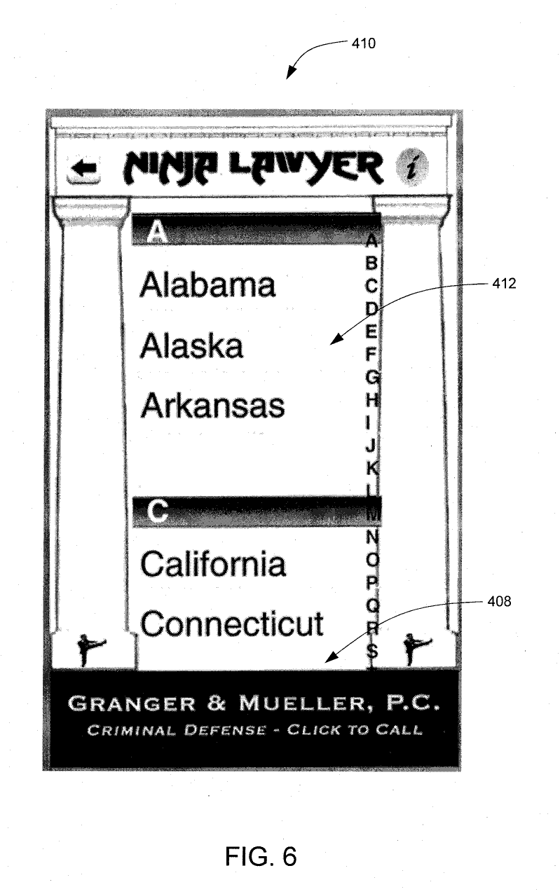

FIG. 6 illustrates an exemplary graphical user interface 410 for a manual selection of a location of interest. In particular, the graphical user interface 410 generally includes a menu section 412 which can provide a list of, e.g., countries, states, cities, counties, and the like, for selection by a user. Thus, a user can be directed through menus and submenus to select a jurisdiction of interest. An advertisement section 408 can remain visible at the graphical user interface 410 and the advertisements may be automatically updated based on a jurisdictional selection by the user.

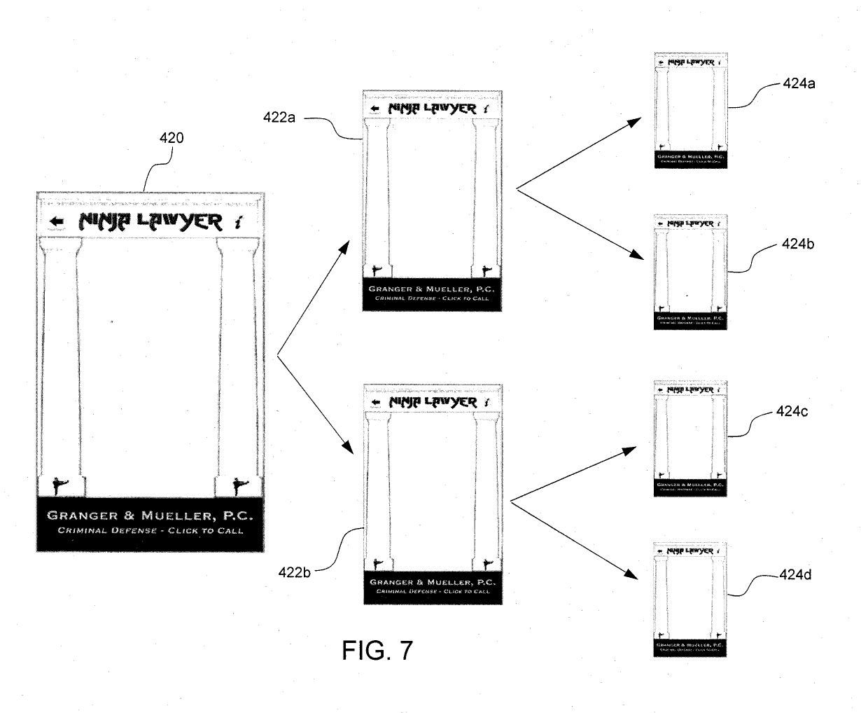

With reference to FIG. 7, exemplary menus and submenus of a graphical user interface are provided. The exemplary menus and submenus can be implemented for, e.g., manually selecting a location of interest, selecting a category of law or field of law, and the like. A main menu 420 can generally be provided to the user to make a selection from the broadest category. A selection at the main menu 420 interface can direct the user to a narrower first submenu 422a, 422b. Based on a selection of the user at the first submenu 422a, 422b level, further submenus or text 424a, 424b, 424c, 424d can be provided. Although shown as having three stages of menus, in some exemplary embodiments, two, three, four, five, six, seven, and the like, menus can be utilized. For example, with respect to selecting a location of interest, the main menu 420 can include a selection of countries, the first submenu 422a, 422b can include a selection of states, and the submenus 424a, 424b, 424c, 424d can include a selection of cities. With respect to selecting a category of law or field of law, the main menu 420 can include a selection of broad categories of law and the first submenu 422a, 422b and the submenus 424a, 424b, 424c, 424d can include narrower categories of law. As would be understood by those of ordinary skill in the art, once a user has reached a narrow selection of a category of law or field of law, rather than a submenu, the graphical user interface can provide text to display the retrieved legal information.

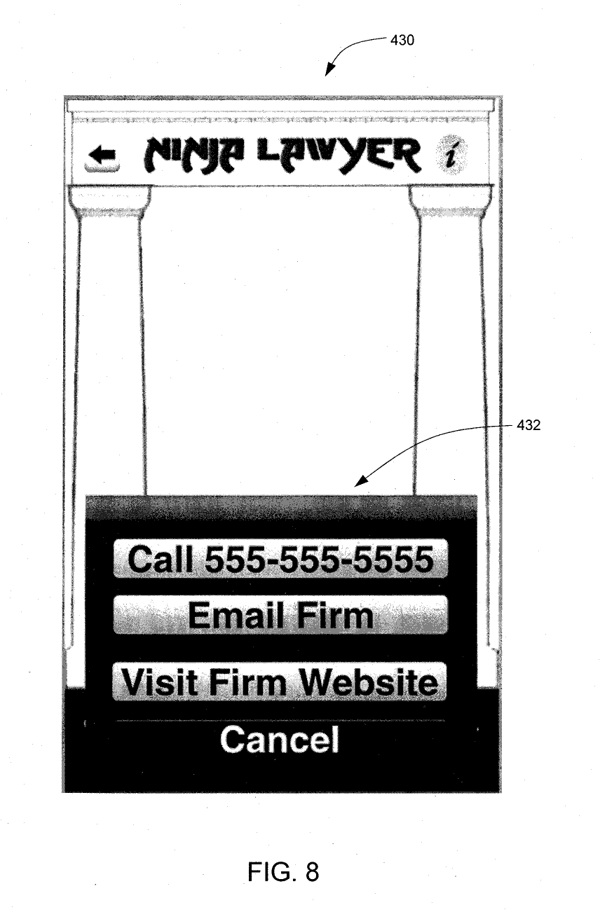

FIG. 8 illustrates an exemplary graphical user interface 430 for an advertisement selection. As discussed above, the exemplary graphical user interfaces can include an advertisement section 408 visible to the user. The advertisement section 408 generally provides, e.g., general advertisements, advertisements related to the location of interest, advertisements related to the selected category of law or field of law, and combinations thereof. If the advertisement section 408 is selected by the user, an advertisement information section 432 can be displayed. The advertisement information section 432 generally provides contact information for the advertising party, e.g., a telephone number, an e-mail address, a website, and the like.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A method for providing location-based information, comprising:
determining a location of interest on a mobile data device;
offering a user a plurality of categories of law or fields of law to select from on a display means of the mobile data device;
allowing the user to select at least one of the plurality of categories of law or fields of law;
retrieving legal information based upon a selection by the user of at least one of the plurality of categories of law or fields of law and the location of interest; and
displaying the retrieved legal information on the display means of the mobile data device.

2. The method of claim 1, wherein determining the location of interest further comprises at least one of determining a current location of the mobile data device with a positioning system and determining the location of interest from a manual input by the user.

3. The method of claim 2, further comprising:
continuously detecting the location of interest;
determining when the location of interest is a location or a jurisdiction where at least one law differs from that of a previous location; and
notifying the user of the mobile data device of alterations in the at least one law between the location of interest and the previous location.

4. The method of claim 1, further comprising:
allowing the user to select, in whole or in part, the retrieved legal information displayed on the display means; and
displaying additional information related to the selection by the user of the retrieved legal information.

5. The method of claim 1, further comprising:
allowing the user to select, in whole or in part, the retrieved legal information displayed on the display means; and
directing the user to an external resource.

6. The method of claim 1, further comprising creating a legal document including at least one of jurisdiction-specific text and text adhering to jurisdiction-specific formatting requirements for public recordation based on the location of interest and the selection of at least one of the plurality of categories of law or fields of law.

7. The method of claim 1, further comprising providing consultation information to the user based on the location of interest and the selection of at least one of the plurality of categories of law or fields of law.

8. The method of claim 7, wherein the consultation information includes at least one of a courthouse location, a plurality of defenses, a plurality of causes of action, and elements for a cause of action.

9. A system for providing location-based information, comprising:
circuitry for determining a location of interest on a mobile data device;
circuitry for offering a user a plurality of categories of law or fields of law to select from on a display means of the mobile data device;
circuitry for allowing a selection by the user of at least one of the plurality of categories of law or fields of law;
circuitry for retrieving legal information based upon the selection by the user of at least one of the plurality of categories of law or fields of law and the location of interest; and
circuitry for displaying the retrieved legal information on the display means of the mobile data device.

10. The system of claim 9, wherein circuitry for determining the location of interest further comprises at least one of circuitry for determining a current location of the mobile data device with a positioning system and circuitry for determining the location of interest from a manual input by the user.

11. The system of claim 10, further comprising:
circuitry for continuously detecting the location of interest;
circuitry for determining when the location of interest is a location or a jurisdiction where at least one law differs from that of a previous location; and
circuitry for notifying the user of the mobile data device of alterations in the at least one law between the location of interest and the previous location.

12. The system of claim 9, further comprising:
circuitry for allowing the user to select, in whole or in part, the retrieved legal information displayed on the display means; and
circuitry for displaying additional information related to the selection by the user of the retrieved legal information.

13. The system of claim 9, further comprising:
circuitry for allowing the user to select, in whole or in part, the retrieved legal information displayed; and
circuitry for directing the user to an external source.

14. The system of claim 9, further comprising circuitry for creating a legal document including at least one of jurisdiction-specific text and text adhering to jurisdiction-specific formatting requirements for public recordation based on the location of interest and the selection of at least one of the plurality of categories of law or fields of law.

15. The system of claim 9, further comprising circuitry for providing consultation information to the user based on the location of interest and the selection of at least one of the plurality of categories of law or fields of law.

16. An apparatus for providing location-based information, comprising:
means for determining a location of interest on a mobile data device,
means for offering a user a plurality of categories of law or fields of law to select from on a display means of the mobile data device,
means for a selection by the user of at least one of the plurality of categories of law or fields of law,
means for retrieving legal information based upon the selection by the user of at least one of the categories of law or fields of law and the location of interest, and
means for displaying the retrieved legal information on the display means of the mobile data device.

17. The apparatus of claim 16, wherein means for determining the location of interest comprise at least one of a positioning system for determining a current location of the mobile data device and a manual input by the user of the location of interest.

18. The apparatus of claim 17, further comprising:
means for continuously detecting the location of interest;
means for determining when the location of interest is a location or a jurisdiction where at least one law differs from that of a previous location; and
means for notifying the user of the mobile data device of alterations in the at least one law between the location of interest and the previous location.

19. The apparatus of claim 16, further comprising:
means for allowing the user to select, in whole or in part, the retrieved legal information displayed on the display means; and
means for displaying additional information related to the selection by the user of the retrieved legal information.

20. The apparatus of claim 16, further comprising:
means for allowing the user to select, in whole or in part, the retrieved legal information displayed on the display means; and
means for directing the user to an external source.

21. The apparatus of claim 16, further comprising means for creating a legal document including at least one of jurisdiction-specific text and text adhering to jurisdiction-specific formatting requirements for public recordation based on the location of interest and the selection of at least one of the plurality of categories of law or fields of law.

22. The apparatus of claim 16, further comprising means for providing consultation information to the user based on the location of interest and the selection of at least one of the plurality of categories of law or fields of law.

23. A computer program product on an electronically discernible medium for providing location-based information, comprising:
instructions for determining a location of interest on a mobile data device;
instructions for offering a user a plurality of categories of law or fields of law to select from on a display means of the mobile data device;
instructions for allowing a selection by the user of at least one of the plurality of categories of law or fields of law;
instructions for retrieving legal information based upon the selection by the user of at least one of the plurality of categories of law or fields of law and the location of interest; and
instructions for displaying the retrieved legal information on the display means of the mobile data device.

24. The computer program product of claim 23, wherein instructions for determining the location of interest comprise at least one of instructions for determining a current location of the mobile data device with a positioning system and instructions for determining the location of interest from a manual input by the user.

25. The computer program product of claim 24, further comprising:
instructions for continuously detecting the location of interest;
instructions for determining when the location of interest is a location or a jurisdiction where at least one law differs from that of a previous location; and
instructions for notifying the user of the mobile data device of alterations in the at least one law between the location of interest and the previous location.

26. The computer program product of claim 23, further comprising:
instructions for allowing the user to select, in whole or in part, the retrieved legal information displayed on the display means; and
instructions for displaying additional information related to the selection by the user of the retrieved legal information.

27. The computer program product of claim 23, further comprising:
instructions for allowing the user to select, in whole or in part, the retrieved legal information displayed; and
instructions for directing the user to an external source.

28. The computer program product of claim 23, further comprising instructions for creating a legal document including at least one of jurisdiction-specific text and text adhering to jurisdiction-specific formatting requirements for public recordation based on the location of interest and the selection of at least one of the plurality of categories of law or fields of law.

29. The computer program product of claim 23, further comprising instructions for providing consultation information to the user based on the location of interest and the selection of at least one of the plurality of categories of law or fields of law.

30. A method for displaying an advertisement, an image and/or associated interactive features on a mobile data device, comprising:
determining a location of interest on the mobile data device;
offering a user a plurality of categories of law or fields of law to select from on a display means of the mobile data device;
allowing the user to select at least one of the plurality of categories of law or fields of law;
retrieving at least one of the advertisement, the image, and the associated interactive features based upon a selection by the user of at least one of the plurality of categories of law or fields of law and the location of interest; and
displaying at least one of the advertisement, the image, and the associated interactive features on the display means of the mobile data device.

31. The method of claim 30, wherein determining the location of interest further comprises at least one of determining a current location of the mobile data device with a positioning system and determining the location of interest from a manual input by the user.

32. The method of claim 30, further comprising allowing the user to communicate with a party associated with at least one of the advertisement, the image, and the associated interactive features by selecting at least one of the advertisement, the image, and the associated interactive features.

33. The method of claim 30, further comprising allowing the user to browse a website of a party associated with at least one of the advertisement, the image, and the associated interactive features by selecting at least one of the advertisement, the image, and the associated interactive features.

34. A system for displaying an advertisement, an image and/or associated interactive features on a mobile data device, comprising:
circuitry for determining a location of interest on the mobile data device;
circuitry for offering a user a plurality of categories of law or fields of law to select from on a display means of the mobile data device;
circuitry for allowing a selection by the user of at least one of the plurality of categories of law or fields of law;
circuitry for retrieving at least one of the advertisement, the image, and the associated interactive features based upon the selection by the user of at least one of the plurality of categories of law or fields of law and the location of interest; and
circuitry for displaying at least one of the advertisement, the image, and the associated interactive features on the display means of the mobile data device.

35. The system of claim 34, wherein circuitry for determining the location of interest further comprises at least one of circuitry for determining a current location of the mobile data device with a positioning system and circuitry for determining the location of interest from a manual input by the user.

36. The system of claim 34, further comprising circuitry for allowing the user to communicate with a party associated with at least one of the advertisement, the image, and the associated interactive features by selecting at least one of the advertisement, the image, and the associated interactive features.

37. The system of claim 34, further comprising circuitry for allowing the user to browse a website of a party associated with at least one of the advertisement, the image, and the associated interactive features by selecting at least one of the advertisement, the image, and the associated interactive features.

38. An apparatus for displaying an advertisement, an image and/or associated interactive features, comprising:
means for determining a location of interest on a mobile data device,
means for offering a user a plurality of categories of law or fields of law to select from on a display means of the mobile data device,
means for allowing a selection by the user of at least one of the plurality of categories of law or fields of law,
means for retrieving at least one of the advertisement, the image, and the associated interactive features based upon the selection by the user of at least one of the plurality of categories of law or fields of law and the location of interest, and
means for displaying at least one of the advertisement, the image, and the associated interactive features on the display means for the mobile data device.

39. The apparatus of claim 38, wherein means for determining the location of interest comprise at least one of a positioning system for determining a current location of the mobile data device and a manual input by the user of the location of interest.

40. The apparatus of claim 38, further comprising means for allowing the user to communicate with a party associated with at least one of the advertisement, the image, and the associated interactive features by selecting at least one of the advertisement, the image, and the associated interactive features.

41. The apparatus of claim 38, further comprising means for allowing the user to browse a website of a party associated with at least one of the advertisement, the image, and the associated interactive features by selecting at least one of the advertisement, the image, and the associated interactive features.

42. A computer program product on an electronically discernible medium for displaying an advertisement, an image and/or associated interactive features on a mobile data device, the system comprising:
instructions for determining a location of interest on the mobile data device;
instructions for offering a user a plurality of categories of law or fields of law to select from on a display means of the mobile data device;
instructions for allowing a selection by the user of at least one of the plurality of categories of law or fields of law;
instructions for retrieving at least one of the advertisement, the image, and the associated interactive features based upon the selection by the user of at least one of the plurality of categories of law or fields of law and the location of interest; and
instructions for displaying at least one of the advertisement, the image, and the associated interactive features on the display means of the mobile data device.

43. The computer program product of claim 42, wherein instructions for determining the location of interest comprise at least one of instructions for determining a current location of the mobile data device with a positioning system and instructions for determining the location of interest from a manual input by the user.

44. The computer program product of claim 42, further comprising instructions for allowing the user to communicate with a party associated with at least one of the advertisement, the image, and the associated interactive features by selecting at least one of the advertisement, the image, and the associated interactive features.

45. The computer program product of claim 42, further comprising instructions for allowing the user to browse a website of a party associated with at least one of the advertisement, the image, and the associated interactive features by selecting at least one of the advertisement, the image, and the associated interactive features.
